(19) United States
(12) Patent Application Publication
(10) Pub. No.: US 2026/0072699 A1
(43) Pub. Date: Mar. 12, 2026

(54) REDUCING BOOT RESPONSE TIME IN A MEMORY SUB-SYSTEM USING A QUICK BOOT CPU CORE

(71) Applicant: Micron Technology, Inc., Boise, ID (US)

(72) Inventor: Jonathan Cao, Shanghai (CN)

(21) Appl. No.: 18/829,726

(22) Filed: Sep. 10, 2024

(51) Int. Cl. G06F 9/4401

(52) U.S. Cl. CPC G06F 9/4406

(57) ABSTRACT

A system comprises a memory device and a primary processing device, operatively coupled with the memory device. The primary processing device loads a primary image and a quick boot image from the memory device. Responsive to loading the primary image and the quick boot image from the memory device, the primary processing device performs a first portion of a boot up operation using the primary image. A quick boot processing device operatively coupled with the memory device, loads the quick boot image from the primary processing device. Responsive to loading the quick boot image, the quick boot processing device performs a second portion of the boot up operation using the quick boot image.

### TECHNICAL FIELD

Embodiments of the disclosure relate generally to memory sub-systems, and more specifically, relate to reducing boot response time in a memory sub-system using a quick boot CPU core.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates an example processor of an example computing system in accordance with some embodiments of the present disclosure.

FIG. 3 is a flow diagram of an example method to perform a portion of boot up operations using a quick boot core, in accordance with some embodiments of the present disclosure.

FIG. 4 is a block diagram of an example computer system in which embodiments of the present disclosure may operate.

### DETAILED DESCRIPTION

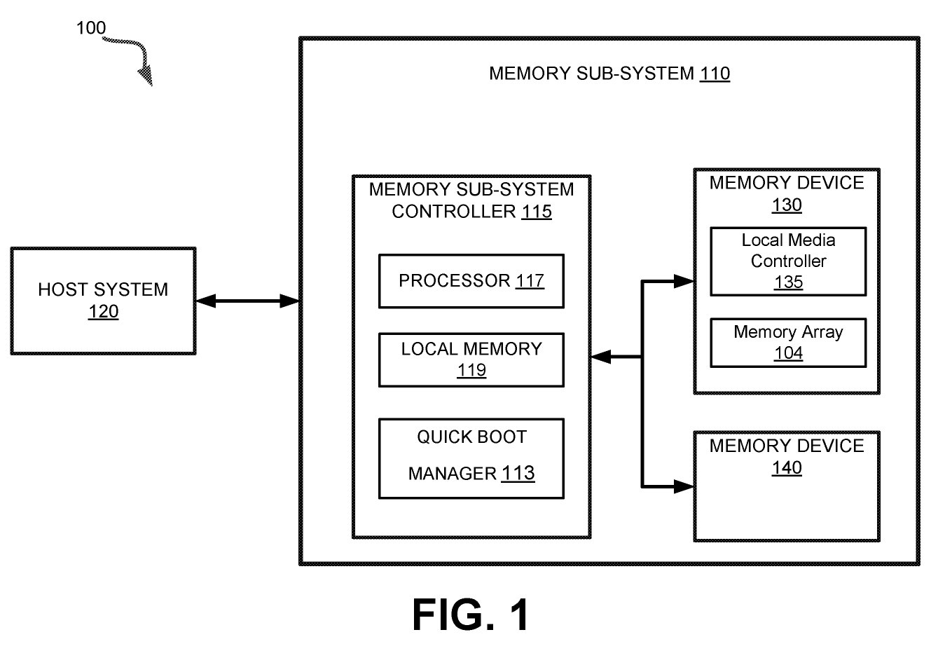

Aspects of the present disclosure are directed to reducing boot response time in a memory sub-system using a quick boot CPU core. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. Each of the memory devices can include one or more arrays of memory cells that are organized in physical blocks of memory cells. A memory cell (“cell”) is an electronic circuit that stores information. Depending on the cell type, a cell can store one or more bits of binary information, and has various logic states that correlate to the number of bits being stored. The logic states can be represented by binary values, such as “0” and “1,” or combinations of such values.

Boot-up is the process of starting a computing device, such as a memory sub-system, and loading runtime software, such as an operating system (OS) or application. Boot sequences of modern computing devices often include multiple boot phases or stages, where each boot phase powers on, loads, verifies, configures, etc. various hardware and software aspects (including, e.g., firmware, microcode, etc.) of the device to ensure all components are initialized and prepared for operation. A conventional boot-up process comprises three phases, each performed using a single processing core: the Read-Only Memory (ROM) phase, the bootloader phase, and the firmware phase.

During the ROM phase, in certain memory sub-systems that employ a memory controller (which includes a processing device and embedded memory), the controller performs a boot using boot firmware. The controller retrieves a read-only memory (ROM) code from an internal ROM of the controller. ROM is a type of non-volatile memory that retains its data even without power, making it ideal for storing essential boot firmware. This firmware, which is immutable, performs the fundamental tasks necessary to start the system. During this phase, the ROM code initializes critical hardware components and loads a firmware known as a bootloader from the NAND into the embedded memory (e.g., volatile memory) of the memory sub-system.

The bootloader phase follows the ROM initialization. A bootloader is a firmware stored in the NAND non-volatile memory. Its primary function is to load a kernel of the operating system (OS) into the system's main memory and manage the system's boot configuration, initializing the OS boot process. It locates the kernel image on the storage device, loads it into memory, and initializes any required hardware or drivers that the kernel needs immediately upon startup, preparing the environment for the OS to run. The bootloader can also provide options for different boot configurations.

Finally, the firmware phase involves loading and initializing the OS, providing low-level control and communication between the hardware and the OS. Firmware, permanently embedded in hardware devices, contains instructions for operating and managing hardware components such as storage devices, network interfaces, and peripheral controllers. During this phase, the OS kernel becomes fully available; the firmware ensures that all hardware components are properly initialized and ready to interact with the OS and other software layers.

The challenge with the conventional boot process is that its multi-phase sequential nature introduces latency that is detrimental to applications that require certain levels of system responsiveness. This is because some functionality (e.g., such as processing a host command) is unavailable until the OS kernel is fully available (e.g., the firmware phase is executed). Each phase, from ROM initialization phase to the bootloader execution phase and finally to the firmware OS loading phase, is performed step-by-step, cumulatively extending the time until a desired functionality can become available.

Aspects of the present disclosure address the above and other deficiencies by using a quick boot CPU core (e.g., a quick boot “core”) to perform a portion of the boot up process independent of the multi-phase boot up sequence (e.g., without the need for a bootloader phase). In some embodiments, a processor (e.g., a central processing unit (CPU)) comprises one or more CPU cores. In an embodiment, the CPU contains a primary core and a quick boot core. During the boot up operation, the primary core loads executable data (an “image”) to the quick boot core, allowing the quick boot core to perform a portion of the boot tasks independently of the boot sequence executed by other system components (e.g., the primary core). In addition, in some embodiments, the quick boot core facilitates the concurrent execution of prioritized boot operations during the boot process.

Advantages of the present disclosure include, but are not limited to, improved system latency. The independent initialization of system components accelerates the availability of specific functionalities. This quick boot core enables the system to prioritize specific boot tasks, ensuring certain functionality is available independently of whether the OS kernel is fully available and executed (e.g., when needed). Furthermore, in some embodiments, the independent nature of the quick boot core allows for concurrent operations with other boot processes performed by the primary CPU core , reducing overall boot times for the system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

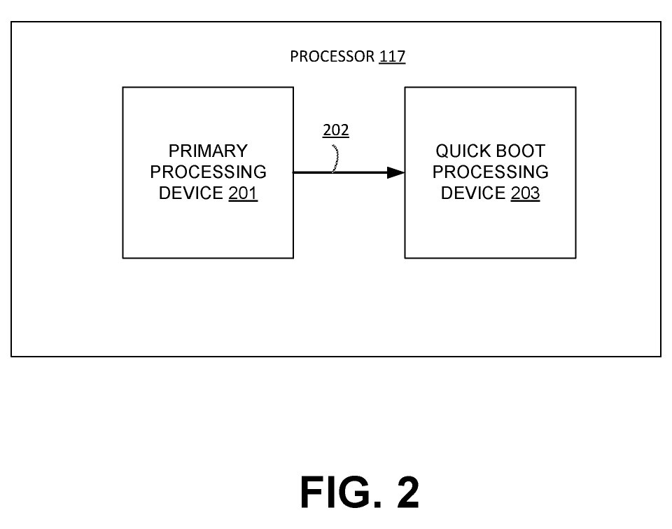

FIG. 2 illustrates an example processor 117 (e.g., a central processing unit (CPU)) of the example computing system 100 of FIG. 1, in accordance with some embodiments of the present disclosure. In embodiments, the processor 117 comprises a primary processing device 201 and a quick boot processing device 203. In embodiments, these processing devices are also known as CPU cores (“cores”).

Referring again to FIG. 1, in some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a quick boot manager component 113 that can manage boot operations between a primary processing device 201 (e.g., a primary “core”) and a quick boot processing device 203 (e.g., a quick boot “core”) to perform a portion of the boot up process independently of a primary boot up sequence. In some embodiments, the memory sub-system controller 115 includes at least a portion of the quick boot manager component 113. In some embodiments, the quick boot manager component 113 is part of the host system 120, an application, or an operating system. In other embodiments, local media controller 135 includes at least a portion of quick boot manager component 113 and is configured to perform the functionality described herein.

The quick boot manager component 113 can manage boot operations between a primary processing device 201 and a quick boot processing device 203 to perform a portion of the boot up process independently of a primary boot up sequence. In some embodiments, the processor 117 (e.g., a CPU) can comprise one or more processing devices (e.g., CPU cores). In an embodiment, the CPU contains a primary processing device 201 and a quick boot processing device 203. During the boot up operation, the primary processing device 201 loads executable code (e.g., an “image”) to the quick boot processing device 203, that allows the quick boot processing device 203 to perform a portion of the boot tasks independently of the boot sequence executed by other system components (e.g., the primary processing device). In addition, in some embodiments, the quick boot processing device 203 facilitates the concurrent execution of prioritized boot operations during the boot process. Further details with regards to the operations of the quick boot manager component 113, the primary processing device 201, and the quick boot processing device 203 are described below.

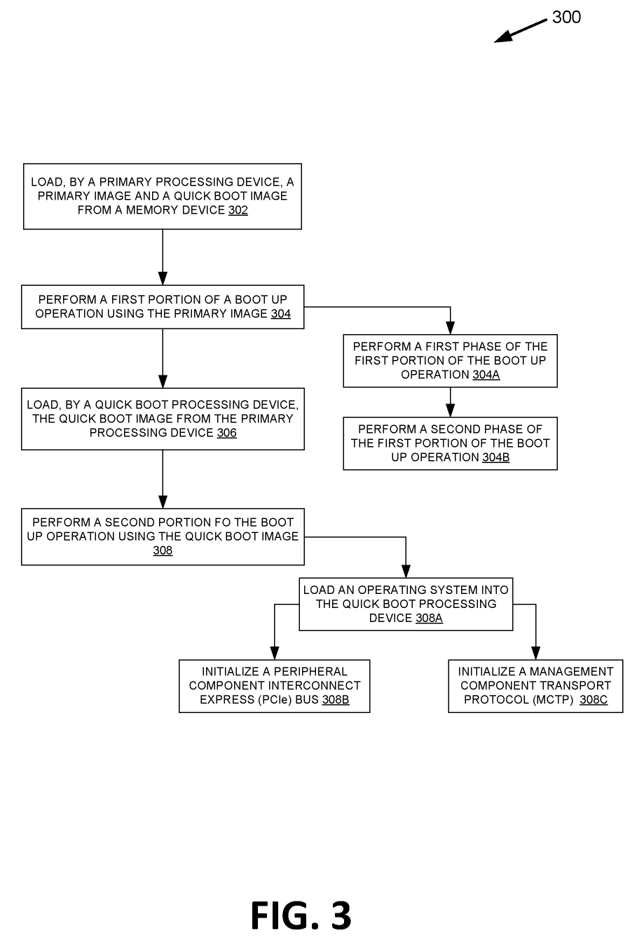

FIG. 3 is a flow diagram of an example method 300 to perform a portion of boot up operations using a quick boot core, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the quick boot manager component 113 of FIG. 1, wherein the quick boot manager component 113 manages boot operations performed by a primary processing device 201 and a quick boot processing device 203. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In some embodiments, the boot process is associated with a cold boot operation. Also known as a hard boot, a cold boot involves booting a system from a completely powered-off state, involving full hardware initialization.

In some embodiments, the boot process is associated with a warm reset operation. A warm reset involves booting a system from a powered-on state. In some embodiments, a warm reset occurs as part of a system update. In some embodiments, a warm reset involves the selection of a restart option within the OS. A warm reset reloads the OS without the full hardware initialization of a cold boot.

At operation 302, the primary processing device 201 loads a primary image and a quick boot image from a memory device. In some embodiments, this operation occurs as part of the “ROM phase,” where the controller 115 loads the images from local memory 119, a non-volatile memory device (e.g., the ROM). An “image” is executable data loaded into memory during the system's startup process. In some embodiments, the image is loaded into a volatile memory device (e.g., a memory device 140). It includes code and data used to load and initialize an OS or other system firmware. In embodiments, images comprise essential code, such as the bootloader, the OS kernel, and drivers to start the hardware and prepare the system for running the full operating system.

Responsive to loading the primary image and the quick boot image from the memory device, at operation 304, the primary processing device 201 performs a first portion of a boot up operation using the primary image. In some embodiments, the primary image comprises executable code to initialize firmware (e.g., the bootloader).

In some embodiments, this first portion of the boot-up process encompasses a number of sequential phases, each consisting of specific tasks for system startup. For example, in some embodiments, at operation 304A, the primary processing device 201 performs a first phase of the first portion of the boot up operation, wherein the first phase comprises loading a firmware into a primary memory device associated with the primary processing device 201 from the primary image. In some embodiments, this first phase is also known as the “bootloader phase.” The firmware (e.g., a bootloader) is a software initially stored in the NAND as part of the primary image. After the ROM phase is complete (e.g., the bootloader is loaded into the system’s volatile memory as part of the image, the firmware is loaded into the primary memory device – in some embodiments, a volatile memory device such as that depicted in FIG. 1 as memory device 140 – associated with the primary processing device. The primary function of the firmware is to load an OS into the system's memory (e.g., memory device 140). The bootloader configures the system settings, initializes necessary resources, and prepares the environment for the OS to run.

At operation 304B, the primary processing device 201 performs a second phase of the first portion of the boot up operation, wherein the second phase comprises the firmware (e.g., the bootloader) loading the OS into the primary processing device associated with the primary processing device 201. In embodiments, this second phase is also known as the “firmware phase.” During this phase, the OS kernel initializes and becomes capable of receiving, processing, and responding to host commands. In some embodiments, the primary processing device executes host commands from the OS data stored in the primary memory device.

At operation 306, the quick boot processing device 203 loads the quick boot image from the primary processing device. This transfer is depicted in FIG. 2 where the quick boot image is loaded from the primary processing device 201 to the quick boot processing device 203 in direction 202. In some embodiments, the quick boot image is requested from the primary processing device by the quick boot processing device upon initiation of the boot up process. In some embodiments, the quick boot image includes the OS kernel and relevant data to allow for the performance of certain boot tasks. As such, the quick boot image does not need to load a firmware to load the OS kernel into the processing device (e.g., the quick boot image does not require the use of a bootloader).

Responsive to loading the quick boot image, at operation 308, the quick boot processing device 203 performs a second portion of the boot up operation using the quick boot image. At operation 308A, the quick boot processing device 203 loads the OS kernel into a quick boot memory device – in some embodiments, a volatile memory device such as that depicted in FIG. 1 as memory device 140 – associated with the quick boot processing device 203. With the OS kernel loaded into the quick boot memory device, in some embodiments, the quick boot processing device executes host commands using the stored OS data. Consequently, the quick boot processing device 203 can execute one or more boot tasks.

For example, in some embodiments, at operation 308B, the quick boot processing device 203 initializes a peripheral component interconnect express (PCIe) bus as part of the second portion of the boot up operation. In some embodiments, initializing a PCIe bus includes setting up the necessary hardware and software to allow PCIe devices to communicate with the host system 120. A PCIe device refers to any hardware component designed to connect to host system 120 via a PCIe interface. Example PCIe devices include hardware such as graphics cards, network cards, storage controllers, and other peripherals.

In an example embodiment, the PCIe bus initialization process includes configuring capabilities and preparing the PCIe bus to accept requests from the host. Additionally, link training is performed. Link training is the process of configuring the connection between PCIe devices and the host to establish an optimal number of data lanes and maximum transfer speed. After these hardware configurations are established, the OS loads drivers for the PCIe devices, which integrate them into the system’s overall architecture and enable their functional operations (e.g., as a part of responding to host commands), thus completing the PCIe bus initialization.

In some embodiments, at operation 308C, the quick boot processing device 203 initializes a management component transport protocol (MCTP) as part of the second portion of the boot up operation. MCTP is a communication protocol for managing interactions and data transfer between system components such as processors, memory controllers, and peripherals, particularly within server architectures. In some embodiments, functions can include facilitating inter-component communication, transmitting event messages, managing remote firmware updates and diagnostics, and implementing security protocols to safeguard management operations.

In an example embodiment, the initialization of MCTP comprises the SMBus (System Management Bus) configuration. MCTP protocol stacks are installed on each endpoint. An MCTP protocol stack refers to a layered set of software or firmware components implemented within devices to handle the functions required for MCTP communications. Once complete, the MCTP is initialized, allowing for system functionality such as responding to host commands.

In some embodiments, the first portion of the boot up operation is performed concurrently with the second portion of the boot up operation. During this concurrent operation, while the primary processing device executes the boot tasks of each sequential phase of the boot process (at operation 304) such as loading the bootloader firmware, the quick boot processing device concurrently carries out prioritized boot tasks (operation 308). In some embodiments, the second portion of the boot operation can include loading operational software, establishing network connections, or initializing systems.

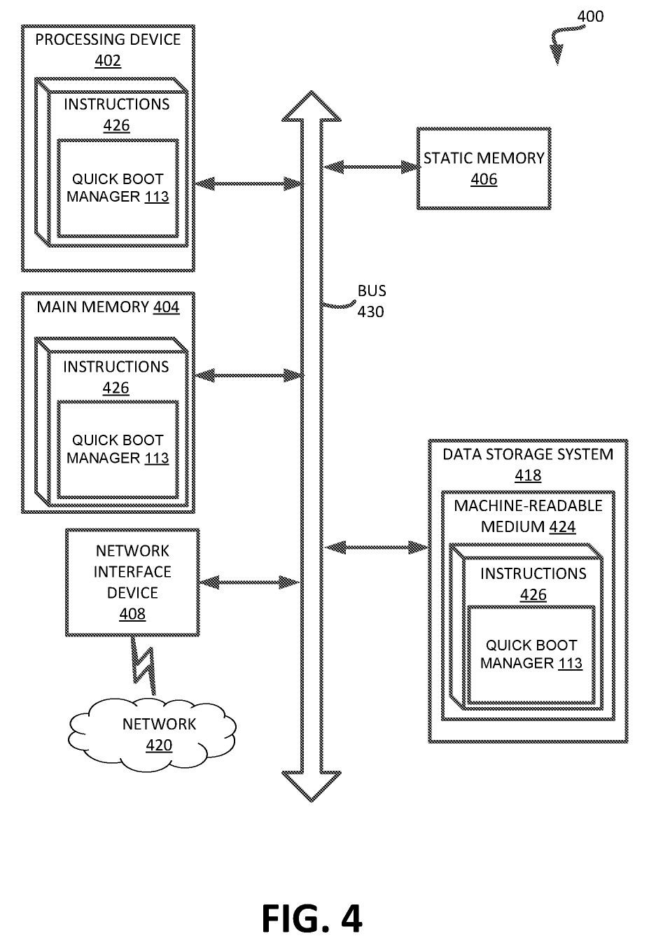

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the quick boot manager component 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to a quick boot manager component (e.g., the quick boot manager component 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a memory device;
a primary processing device, operatively coupled with the memory device, to perform operations comprising:
loading a primary image and a quick boot image from the memory device; and
responsive to loading the primary image and the quick boot image from the memory device, performing a first portion of a boot up operation using the primary image; and
a quick boot processing device operatively coupled with the memory device, to perform operations comprising:
loading the quick boot image from the primary processing device; and
responsive to loading the quick boot image, performing a second portion of the boot up operation using the quick boot image.

2. The system of claim 1, wherein performing the first portion of the boot up operation using the primary image comprises:
performing a first phase of the first portion of the boot up operation, wherein the first phase comprises loading a firmware into a primary memory device associated with the primary processing device; and
performing a second phase of the first portion of the boot up operation, wherein the second phase comprises the firmware loading an operating system into the primary memory device associated with the primary processing device.

3. The system of claim 1, wherein performing the second portion of the boot up operation using the quick boot image comprises:
loading an operating system into a quick boot memory device associated with the quick boot processing device.

4. The system of claim 3, wherein performing the second portion of the boot up operation using the quick boot image further comprises:
initializing a peripheral component interconnect express (PCIe) bus.

5. The system of claim 3, wherein performing the second portion of the boot up operation using the quick boot image further comprises:
initializing a management component transport protocol (MCTP).

6. The system of claim 1, wherein the first portion of the boot up operation is performed concurrently with the second portion of the boot up operation.

7. The system of claim 1, wherein the primary image and the quick boot image are loaded responsive to a cold boot of the system.

8. The system of claim 1, wherein the primary image and the quick boot image are loaded responsive to a warm reset of the system.

9. A method comprising:
loading, by a primary processing device, a primary image and a quick boot image from a memory device;
responsive to loading the primary image and the quick boot image from the memory device, performing a first portion of a boot up operation using the primary image;
loading, by a quick boot processing device, the quick boot image from the primary processing device; and
responsive to loading the quick boot image, performing a second portion of the boot up operation using the quick boot image.

10. The method of claim 9, wherein performing the first portion of the boot up operation using the primary image comprises:
performing a first phase of the first portion of the boot up operation, wherein the first phase comprises loading a firmware into a primary memory device associated with the primary processing device; and
performing a second phase of the first portion of the boot up operation, wherein the second phase comprises the firmware loading an operating system into the primary memory device associated with the primary processing device.

11. The method of claim 9, wherein performing the second portion of the boot up operation using the quick boot image comprises:
loading an operating system into a quick boot memory device associated with the quick boot processing device.

12. The method of claim 11, wherein performing the second portion of the boot up operation using the quick boot image further comprises:
initializing a peripheral component interconnect express (PCIe) bus.

13. The method of claim 11, wherein performing the second portion of the boot up operation using the quick boot image further comprises:
initializing a management component transport protocol (MCTP).

14. The method of claim 9, wherein the first portion of the boot up operation is performed concurrently with the second portion of the boot up operation.

15. A non-transitory computer-readable storage medium comprising instructions that, when executed by a primary processing device and a quick boot processing device, cause the primary processing device and the quick boot processing device to perform operations comprising:
loading, by the primary processing device, a primary image and a quick boot image from a memory device;
responsive to loading the primary image and the quick boot image from the memory device, performing a first portion of a boot up operation using the primary image;
loading, by the quick boot processing device, the quick boot image from the primary processing device; and
responsive to loading the quick boot image, performing a second portion of the boot up operation using the quick boot image.

16. The non-transitory computer-readable storage medium of claim 15, wherein performing the first portion of the boot up operation using the primary image comprises:
performing a first phase of the first portion of the boot up operation, wherein the first phase comprises loading a firmware into a primary memory device associated with the primary processing device; and
performing a second phase of the first portion of the boot up operation, wherein the second phase comprises the firmware loading an operating system into the primary memory device associated with the primary processing device.

17. The non-transitory computer-readable storage medium of claim 15, wherein performing the second portion of the boot up operation using the quick boot image comprises:
loading an operating system into a quick boot memory device associated with the quick boot processing device.

18. The non-transitory computer-readable storage medium of claim 17, wherein performing the second portion of the boot up operation using the quick boot image further comprises:
initializing a peripheral component interconnect express (PCIe) bus.

19. The non-transitory computer-readable storage medium of claim 17, wherein performing the second portion of the boot up operation using the quick boot image further comprises:
initializing a management component transport protocol (MCTP).

20. The non-transitory computer-readable storage medium of claim 15, wherein the first portion of the boot up operation is performed concurrently with the second portion of the boot up operation.
